(19) United States
(12) Patent Application Publication
(10) Pub. No.: US 2024/0089500 A1
(43) Pub. Date: Mar. 14, 2024

(54) METHOD FOR MULTIVIEW VIDEO DATA ENCODING, METHOD FOR MULTIVIEW VIDEO DATA DECODING, AND DEVICES THEREOF

(71) Applicant: GUANGDONG OPPO MOBILE TELECOMMUNICATIONS CORP., LTD., Dongguan (CN)

(72) Inventors: Marek DOMANSKI, Poznan (PL); Tomasz GRAJEK, Poznan (PL); Adam GRZELKA, Poznan (PL); Slawomir MACKOWIAK, Poznan (PL); Slawomir ROZEK, Poznan (PL); Olgierd STANKIEWICZ, Poznan (PL); Jakub STANKOWSKI, Poznan (PL)

(21) Appl. No.: 18/519,009

(22) Filed: Nov. 26, 2023

Related U.S. Application Data
(63) Continuation of application No. PCT/CN2021/107995, filed on Jul. 22, 2021.

(30) Foreign Application Priority Data
May 26, 2021 (EP) 21461544.5

(51) Int. Cl. H04N 19/597; H04N 19/172; H04N 19/65

(52) U.S. Cl. CPC H04N 19/597; H04N 19/172; H04N 19/65

(57) ABSTRACT

A method for multiview video data encoding is provided. The method includes: performing feature detection on first picture data relating to a first view to obtain a first set of features corresponding to said first view; generating a picture bitstream based on the first picture data relating to the first view; performing feature detection on second picture data relating to a second view to obtain a second set of features corresponding to said second view; performing feature matching of the first and second sets of features so as to identify an area of common characteristics; and performing prediction on second input picture data based on the area of common characteristics so as to generate a residual data bitstream.

### CROSS REFERENCE TO RELATED APPLICATION(S)

This application is a continuation of International Application No. PCT/CN2021/107995, filed Jul. 22, 2021, which claims priority to European Patent Application No. 21461544.5, filed May 26, 2021, the entire disclosures of which are incorporated herein by reference.

### TECHNICAL FIELD

The present invention relates to the technical field of picture and/or video processing and more particular to a method for multiview video data encoding, a method for multiview video data decoding, and devices thereof.

### BACKGROUND

Video compression is a challenging technology that, in particular, becomes more and more important in the context of network and wireless network content transmission. Classic video and image compression has been developed independently from encoding of features of images and video. Such an approach seems to be inefficient for the contemporary applications that need high-level video analysis at various locations of the video-based systems like connected vehicles, advanced logistics, smart city, intelligent video surveillance, autonomous vehicles including cars, UAVs, unmanned trucks and tractors, and numerous other applications related to IoT (Internet of Things) as well as augmented and virtual reality systems. Most such systems use transmission links that have limited capacity, in particular, wireless links that exhibit limited throughput, because of physical, technical and economical limitations. Therefore, the compression technology is crucial for these applications.

In the abovementioned applications, video or image is consumed often not by a human being but by machines of very different types: navigation systems, automatic recognition and classification systems, sorting systems, accident prevention systems, security systems, surveillance systems, access control systems, traffic control systems, fire and explosion prevention systems, remote operation (e.g. remote surgery or treatment) and virtual meeting systems (e.g. virtual immersion) and very many others. In such applications, the compression technology shall be designed by such means that automatic video analysis will be not hindered when using the decompressed image or video.

In addition to “simple” video and picture systems there are also systems that provide more than one single view of some scene, which is usually referred to as “multiview” video and imaging. One example for multiview is three-dimensional (3-D) video in which a user can enjoy comprehensive and spatial views of a given scene. The compression of multiview video in, for example, an end-to-end 3D system may pose substantial demands on data and information transmission. It may be thus required to reduce the amount of visual information. Since multiple cameras usually have a common/overlapping field of view, high compression ratios can be achieved if the inter-view redundancy is exploited. The inter-view prediction is used to predict the content of View i+1 from the previously encoded View i. Such inter-view prediction is known since several decades.

Coding usually involves encoding and decoding. Encoding is the process of compressing and potentially also changing the format of the content of the picture or the video. Encoding is important as it reduces the bandwidth needed for transmission of the picture or video over wired or wireless networks. Decoding on the other hand is the process of decoding or uncompressing the encoded or compressed picture or video. Since encoding and decoding is applicable on different devices, standards for encoding and decoding called codecs have been developed. A codec is in general an algorithm for encoding and decoding of pictures and videos.

Usually, picture data is encoded on an encoder side to generate bitstreams. These bitstreams are conveyed over data communication to a decoding side where the streams are decoded so as to reconstruct the image data. Thus pictures, images and videos may move through the data communication in the form of bitstreams from the encoder (transmitter side) to the decoder (receiving side), and that any limitations of said data communication may result in losses and/or delays in the bitstreams, which, ultimately may result in a lowered image quality at the decoding and receiving side. Although image data coding and feature detection already provide a great deal of data reduction for communication, the conventional techniques still suffer from various drawbacks.

Therefore, there is a need for an efficient technology for Multiview video and picture coding. The decoded image or video and visual features should maintain better quality as compared to independent coding of image or video and visual features by the same total bitrate.

### SUMMARY

According to a first aspect of the present invention there is provided a method for multiview video data encoding comprising the steps of performing feature detection on first picture data relating to a first view to obtain a first set of features corresponding to said first view; generating a picture bitstream based on the first picture data relating to the first view; performing feature detection on second picture data relating to a second view to obtain a second set of features corresponding to said second view; performing feature matching of the first and second sets of features so as to identify an area of common characteristics; and performing prediction on second input picture data based on the area of common characteristics so as to generate a residual data bitstream.

According to a second aspect of the present invention there is provided a method for multiview video data decoding comprising the steps of obtaining a picture bitstream; obtaining a residual data bitstream; decoding encoded picture data conveyed by said picture bitstream so as to obtain first picture data relating to a first view; obtaining a prediction error from said residual data bitstream; and generating second picture data relating to a second view from said prediction error and at least a part of said decoded first picture data.

According to a third aspect of the present invention there is provided a multiview video data encoding device comprising a processor and an access to a memory to obtain code that instructs said processor during operation to perform the method of the first aspect.

According to a fourth aspect of the present invention there is provided a multiview video data decoding device comprising a processor and an access to a memory to obtain code that instructs said processor during operation to: obtain a picture bitstream; obtain a residual data bitstream; decode encoded picture data conveyed by said picture bitstream so as to obtain first picture data relating to a first view; obtain a prediction error from said residual data bitstream; and generate second picture data relating to a second view from said prediction error and at least a part of said decoded first picture data.

Other features and aspects of the disclosed features will become apparent from the following detailed description, taken in conjunction with the accompanying drawings, which illustrate, by way of example, the features in accordance with embodiments of the disclosure. The summary is not intended to limit the scope of any embodiments described herein.

### BRIEF DESCRIPTION OF THE DRAWINGS

Embodiments of the present invention, which are presented for better understanding the inventive concepts but which are not to be seen as limiting the invention, will now be described with reference to the figures in which:

FIG. 1A shows a schematic view of configuration embodiments of the present invention;

FIG. 1B shows a schematic view of other configuration embodiments of the present invention;

FIGS. 2A and 2B show exemplary embodiments for defining areas in a picture,

FIG. 3A shows a schematic view of a general device embodiment for the encoding side according to an embodiment of the present invention;

FIG. 3B shows a schematic view of a general device embodiment for the decoding side according to an embodiment of the present invention;

FIGS. 4A & 4B show flowcharts of general method embodiments of the present invention; and

FIG. 5 shows a schematic view of components of a general application of the embodiments of the present invention.

### DETAILED DESCRIPTION

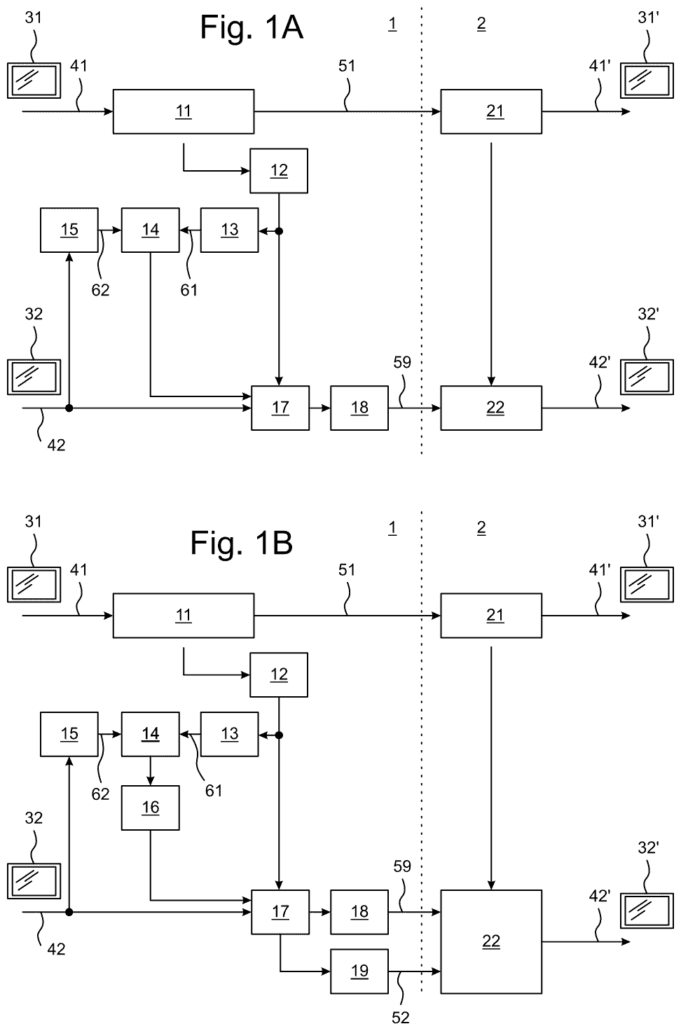

FIG. 1A shows a schematic view of configuration embodiments of the present invention. Specifically, there are shown the general aspects and features of multiview video data encoding and decoding, generally coding, according to the respective embodiments of the present invention. Specifically, there is shown the provision of first input picture data 41 that relates to a first view 31 of some given scene. For example, the first view may correspond to a left-eyes view of a scene in a 3D-video system. The system may comprise a first encoder 11 configured to encode the first input picture data 41 so as to generate a first picture bitstream 51 based on the first picture data relating to the first view 31.

In a first feature detector 13, there is performed feature detection on first picture data relating to the first view 31 to obtain a first set 61 of features corresponding to this first view. The features may be detected directly from the first input picture data 41 or from the encoded and again decoded picture data. For the latter option, there may be provided a local decoder 12 that decodes the output from the first encoder 11. This option thus involves encoding the first input picture data 41 relating to the first view 31 to obtain encoded picture data as a basis for generating the picture bitstream 51 and decoding said encoded picture data so as to obtain decoded picture data, wherein feature detection by the feature detector 13 is performed on said decoded encoded picture data to obtain the first set of features 61.

In a second feature detector 15, there is performed feature detection on second picture data 42 relating to a second view 32 to obtain a second set 62 of features corresponding to said second view. In a feature matcher 14, there is performed feature matching of the first set 61 of features and the second set 62 of features so as to identify an area of common characteristics. In other words, there is identified the part of the second view that is at least in part similar to content of the first view. It is understood that this similar or common part may appear in the second view in a different form as in the first view. For example, the common part may reappear in the second view in another size, skew, brightness, color, orientation, and the like. However, the common part may be reproduced for the second view from the part in the first view and information on the difference.

In a predictor 17, there is performed prediction on the second input picture data based on the area of common characteristics so as to generate a residual data, which, in turn, is encoded in a further encoder 18 so as to generate a residual data bitstream 59. Both bitstreams 51 and 59 can be conveyed from the encoder side 1 to a decoder side 2 via any one of a network, a mobile communication network, a local area network, a wide area network, the Internet, and the like. This data transmission may employ the corresponding protocols, techniques, procedures, and infrastructure that are as such known from the prior arts.

Generally, in the feature matcher 14, there is identified an area of common characteristics in both views 31, 32. For this purpose, the first set 61 of features and the second set 62 of features are matched and it can be determined what features a present, even if in different form (size, color, etc.), in both views. These areas can be defined by any suitable parameters that can define areas in pictures. In one embodiment, the feature matcher 14 determining a set of positions defining the area of common characteristics. For example, these positions can be in the form of points or keypoints that together or in combination with other parameters define an area in a picture. In this context, keypoint extraction methods may be considered such as SIFT, CDVS, CDVA, but shall not be restricted to the explicitly stated techniques.

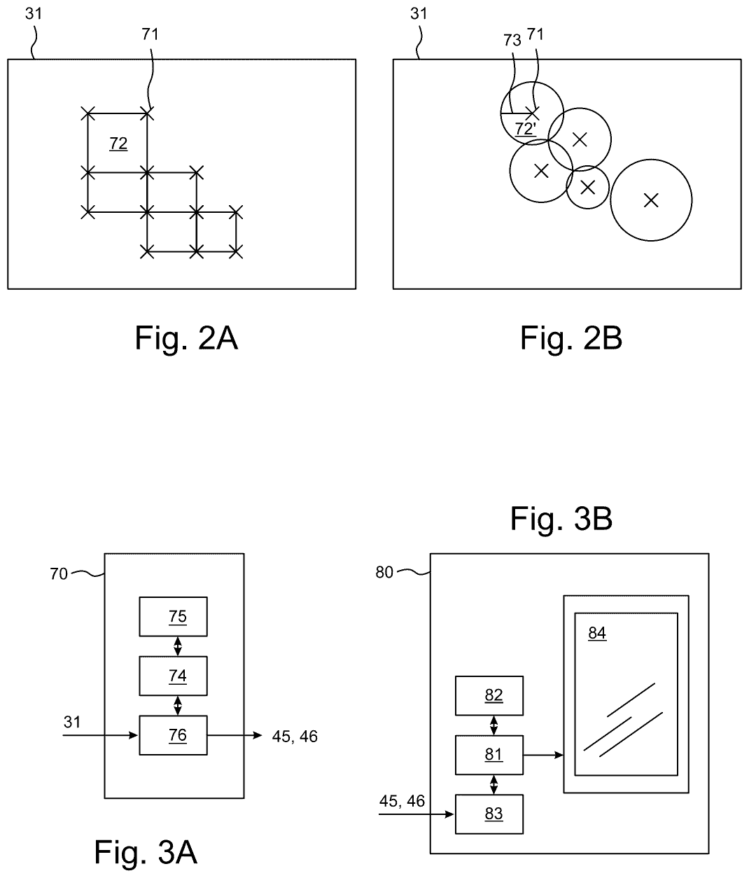

At this point it is referred to FIGS. 2A and 2B, showing exemplary embodiments for defining areas in a picture. As shown in FIG. 2A, areas 72 can be defined by a set of points 71 (positions, keypoints) that are interpreted as corners of rectangular areas 72 that cover the area like in the form of tiles. As shown in FIG. 2B, areas 72′ can be defined by a set of points 71 (positions, keypoints) that are interpreted as centres of circular areas 72′ together with respective radii 73 as a parameter, that again cover the area like in the form of bubbles.

The predictor 17 may perform prediction by including deciding on a prediction mode based on the area of common characteristics and/or determining an extent of a prediction area based on the area of common characteristics. Said extent of the prediction area can be determined in the form of prediction size units. In this way, on the encoder side there may be decided a prediction mode based on an area of common characteristics in said first view and said second view, and on the decoding side, this decided prediction mode may be used to generate the second view from the first view and the prediction error, or, generally, the difference information on the difference between the first and the second view.

On the decoding side 2, multiview video data can be decoded. A picture bitstream 51 is obtained on the decoding side 2 and in a decoder 21 encoded picture data conveyed by said picture bitstream 51 is decoded so as to obtain first picture data relating to the first view 31 and reproduces the corresponding first view 31′ on the decoding side 2. Further, a residual data bitstream 59 is obtained and decoded in a decoder 22, where a prediction error is obtained from said residual data bitstream 59. In this way, at least a part of second picture data relating to the second view 32 can be generated from said prediction error and at least a part of said decoded first picture data. The generating of the second picture data can include obtaining a second picture bitstream 52 and decoding encoded picture data conveyed by said second picture bitstream 52 so as to obtain remaining picture data being combined with the second picture data for reproducing the second view 32 in form of the reproduced second view 32′.

Generally, the embodiments for the decoding side may also comprise provisions for de-multiplexing bitstreams from a multiplexed bitstream received from the encoding side 1. Further, the picture data may generally include data that contains, indicates and/or can be processed to obtain an image, a picture, a stream of pictures/images, a video, a movie, and the like, wherein, in particular, a stream, video or a movie may contain one or more pictures.

FIG. 1B shows a schematic view of other configuration embodiments of the present invention. It is noted that the configuration is similar to that presented and disclosed in conjunction with FIG. 1A, therefore repeated description of like or similar features is omitted whilst maintaining the same reference numerals. In the respective embodiments, there is generated a further picture bitstream 52 based on the second picture data relating to the second view 32 and the area of common characteristics in a further encoder 19. In this way, a scene can be conveyed completely and efficiently by means of the bitstreams 51, 52, and 59.

Specifically, the further bitstream 52 conveys the picture data for the second view that is not conveyed by means of the common characteristics in the form of the first picture bitstream 51 and the residual bitstream 59. The further bitstream 52 thus conveys so to speak the remainder of the second view 32 that is not common to the first view 31 or cannot predicted from any parts of that first view 31. In addition, there may provided a control unit 16 that effects the control of the predictor 17 on the basis of the matched features produced by the feature matcher 14.

In a sense, there is thus provided a kind of inter-view prediction, which uses the information about the matched keypoints, i.e. the corresponding keypoints that exist in both the first and second views, generally a ith view and a jth view, where j may be equal to (i+1). The information about the matched keypoints can then be used in a view prediction in the encoder. In the encoder, matched keypoints are used in the intra-view prediction, i.e. the prediction of view j with the reference to view i. The matched keypoints can be used to propose a type of prediction on the data structure defined in the encoder and specify the area indicated by the position of the matched keypoints and the size of the prediction unit.

Positions, or “keypoints”, can be extracted from at least two views, e.g. views i & j, and it is then checked which keypoints are compliant, i.e. the sets of matched keypoints are estimated. The spatial matching of keypoints can be determined on the basis of known and typical matching techniques. The common area, bounded by a set of matched keypoints, from view i can be set as a prediction area in view j, and the prediction residual can be encoded. On the decoder side, the prediction can obtained via view synthesis using the image fragment of view i and the prediction error sent between views to retrieve this area. It can be assumed that the content approximating the content of view i can be used as a prediction for view j in the form of areas defined by the structure, shape and size of the unit processed in the encoder.

Therefore, several views can be encoded efficiently by encoding view i, and extracting the keypoints on the decoded view i and view j. The encoder can be any encoder of any image/video compression technology. A keypoint matching can then be performed between the keypoints from the decoded view i and view j. This keypoint matching can use one of the known techniques. The information about the set of matching keypoints, together with the parameters of these keypoints can be the information for encoder control. Specifically, this information can be used to choose the prediction mode. These may be, for example, decisions determining the extent of the prediction area (in the prediction size units of a given encoder type), dependent on information about the extent of the keypoint analysis.

On the decoder side, View i is decoded independently, while the decoding of View i+1 uses information about the prediction type (prediction method, prediction scheme), which, based on this type, performs the function of combining the prediction error with the decoded portion of the View i and thus creating the information that forms View i+1 at that location for this prediction block.

On the decoding side 2, the second decoder 22 may reproduce the second view 32′ in part from the common characteristics already conveyed by means of the first picture bitstream 51 under consideration of the prediction differences conveyed by means of the residual bitstream 59. The remaining part of the second view 32′ can be reconstructed from decoding the second bitstream 52 that conveys the “missing” parts that are not present as common characteristics in both views 31 and 32.

In one embodiment, there is thus provided the generation of second picture data that includes combining the prediction error with at least the part of the decoded first picture data. Specifically, the decoder 22 as shown in FIG. 1B may generate picture data for the common aspects by receiving decoded data relating to the first view from decoder 21 and translate this to the second view by means of applying the difference data decoded from residual data bitstream 59. The rest of the second view is generated from the further picture data bitstream 52, and the full second view is reconstructed at the decoding side 2 as views 32′.

Generally, the embodiments of the present invention may consider that all steps necessary for compiling the bitstreams, e.g. bitstreams 51, 52, and 59 of FIGS. 1A and 1B, are performed on an on the encoder side 2. Further, the bitstreams or some bitstreams may be multiplexed into one data stream suitable to conveyed from the encoding side 1 toward the decoding side 2. As a further generally applicable summary, the embodiments of the present disclosure may implement a form of view synthesis prediction as a new coding tool for multiview video that can essentially generate virtual views of a scene using images from neighboring cameras and exploits the features extracted from the views.

FIG. 3A shows a schematic view of a general device embodiment for the encoding side according to an embodiment of the present invention. An encoding device 70 comprises processing resources 74, a memory access 75 as well as an interface 76. The mentioned memory access 75 may store code or may have access to code that instructs the processing resources 74 to perform the one or more steps of any method embodiment of the present invention an as described and explained in conjunction with the present disclosure.

Specifically, the code may instruct the processing resources 74 to perform feature detection on first picture data relating to a first view to obtain a first set of features corresponding to said first view; to generate a picture bitstream based on the first picture data relating to the first view; to perform feature detection on second picture data relating to a second view to obtain a second set of features corresponding to said second view; to perform feature matching of the first and second sets of features so as to identify an area of common characteristics; and to perform prediction on the second input picture data based on the area of common characteristics so as to generate a residual data bitstream.

Said processing resources can be embodies by one or more processing units, such as a central processing unit (CPU), or may also be provided by means of distributed and/or shared processing capabilities, such as present in a datacentre or in the form of so-called cloud computing. Similar considerations apply to the memory access which can be embodied by local memory, including but not limited to, hard disk drive(s) (HDD), solid state drive(s) (SSD), random access memory (RAM), FLASH memory. Likewise, also distributed and/or shared memory storage may apply such as datacentre and/or cloud memory storage.

FIG. 3B shows a schematic view of a general device embodiment for the decoding side according to an embodiment of the present invention. A decoding device 80 comprises processing resources 81, a memory access 82 as well as an interface 83. The mentioned memory access 82 may store code or may have access to code that instructs the processing resources 81 to perform the one or more steps of any method embodiment of the present invention an as described and explained in conjunction with the present disclosure. Further, the device 80 may comprise a display unit 84 that can receive display data from the processing resources 81 so as display content in line with picture data. The device 80 can generally be a computer, a personal computer, a tablet computer, a notebook computer, a smartphone, a mobile phone, a video player, a tv set top box, a receiver, etc. as they are as such known in the arts.

Specifically, the code may instruct the processing resources 81 to obtain a picture bitstream; obtain a residual data bitstream; decode encoded picture data conveyed by said picture bitstream so as to obtain first picture data relating to a first view; obtain a prediction error from said residual data bitstream; and generate second picture data relating to a second view from said prediction error and at least a part of said decoded first picture data.

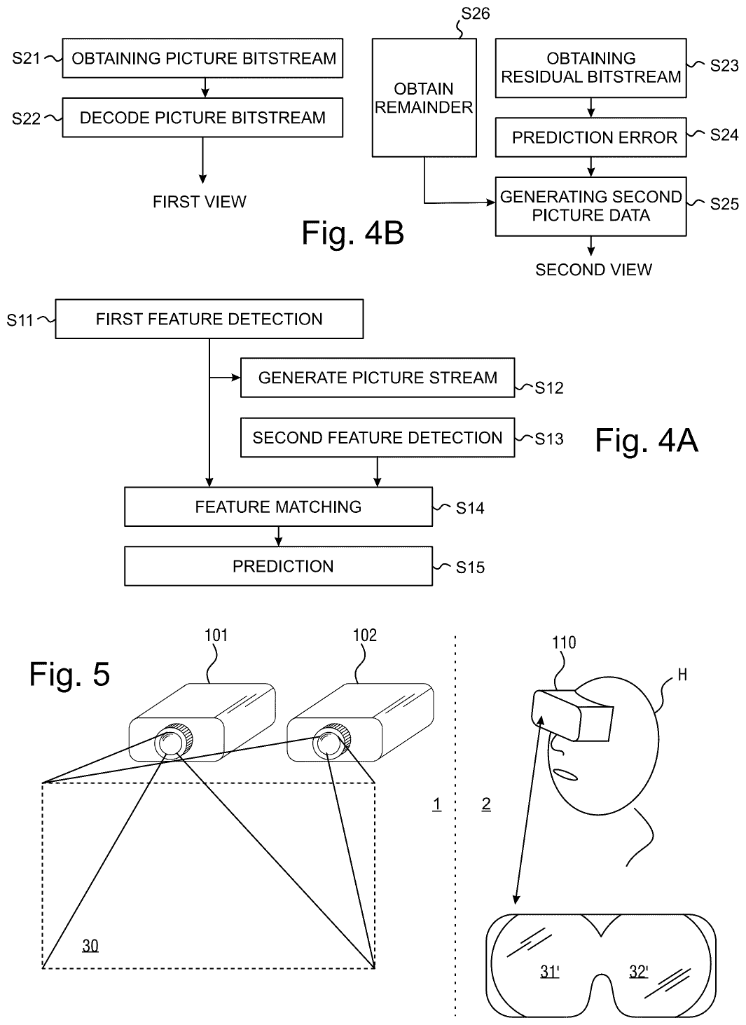

FIG. 4A shows a flowchart of general method embodiment of the present invention that refers to encoding multiview video data. Specifically, the embodiment provides a method for multiview video data encoding and comprises the following: a step S11 of performing feature detection on first picture data relating to a first view to obtain a first set of features corresponding to said first view. In a step S12 there is generated a picture bitstream based on the first picture data relating to the first view, wherein said picture bitstream may be conveyed toward a receiving decoding side for reproducing the first view. In a step S13 of there is performed feature detection on second picture data relating to a second view to obtain a second set of features corresponding to said second view.

In a step S14 there is performed feature matching of the first and second sets of features so as to identify an area of common characteristics. In a way, the result of steps S11 and S13 are fed into a feature matcher for determining matching features that may generally conveyed only once toward a receiving decoding side so as to reproduced there in more than one view, thus contributing to data and compression efficiency. In a step S15 there is then performed prediction on the second input picture data based on the area of common characteristics so as to generate a residual data bitstream to be also conveyed toward a receiving or decoding side.

FIG. 4B shows a flowchart of general method embodiment of the present invention that refers to decoding multiview video data. The method comprises a step S21 of obtaining a picture bitstream and a step S22 of decoding encoded picture data conveyed by said picture bitstream so as to obtain first picture data relating to a first view. Further, a step S23 of obtaining a residual data bitstream and a step S24 of obtaining a prediction error from said residual data bitstream is provided. In a step S25 there is generated second picture data relating to a second view from said prediction error and at least a part of said decoded first picture data. The generation of the second picture data is thus based on the error indicating a difference between the first and the second view. A part of the second view can thus be reproduced from information on the first view considering a respective difference, e.g. how same or similar features of the first view reappear in the second view. Further, in a step S26 there is obtained a remainder of the second view, i.e. that portion of the second view that cannot be reproduced from or that does not reappear in the first view (for example, by means of a further bitstream 52 as explained in conjunction with above FIG. 1B).

In a specific decoding method embodiment, there may be employed a decision rendered on the encoding side based on the area of common characteristics and/or determining an extent of a prediction area based on the area of common characteristics, i.e. the characteristics that are common to the first and second view. This decided prediction mode may be used to generate the second view from the first view and the prediction error, or, generally, the difference information on the difference between the first and the second view.

FIG. 5 shows a schematic view of components of a general application of the embodiments of the present invention. For example, toward the encoding side 1 there are arranged two cameras 101, 102 that are capable to capture respective views of one scene view 30. The captured Multiview content is processed and conveyed to toward a decoding side 2 according to the embodiments of the present invention. There, a human observer H can employ a multiview display device in the view of 3D glasses 110 so as to be presented with views 31′ and 32′ for the respective eyes.

Generally, in multiview video coding, inter-view prediction can thus be used to reduce the data redundancy related to similarities and correlations between views. The present disclosure acknowledges the observation that the features extracted from pictures may be used as additional information available for inter-view prediction and it is thus considered an approach exploiting the observation that the visual appearance of different views of the same scene can be highly correlated.

In summary, there is provided a technique that the area of prediction (defined structure in the encoder) can be conditioned by the presence and result of matched keypoints in two views. Thus, there is provided a linking of the decision to subject the prediction of the image encoding structure to the occurrence of a matched keypoints and their parameters, while there are no restrictions on the prediction technique or the shape of the area. The information on the keypoint matching may not assume binary information about keypoints matching, but also fuzzy values (probability, ranking) that can be used to refine the selection of prediction types, prediction schemes in the encoder, e.g. 3D HEVC. Further, the present disclosure can be applied to various image/video encoding methods, including codecs like HEVC, VVC, AVi and others.

Although detailed embodiments have been described, these only serve to provide a better understanding of the invention defined by the independent claims and are not to be seen as limiting.

1. A method for multiview video data encoding, comprising:
performing feature detection on first picture data relating to a first view to obtain a first set of features corresponding to said first view;
generating a picture bitstream based on the first picture data relating to the first view;
performing feature detection on second picture data relating to a second view to obtain a second set of features corresponding to said second view;
performing feature matching of the first and second sets of features so as to identify an area of common characteristics; and
performing prediction on second input picture data based on the area of common characteristics so as to generate a residual data bitstream.

2. The method according to claim 1, further comprising:
encoding first input picture data relating to the first view to obtain encoded picture data as a basis for generating the picture bitstream;
decoding said encoded picture data so as to obtain decoded picture data, wherein feature detection is performed on said decoded encoded picture data to obtain the first set of features.

3. The method according to claim 1, further comprising a step of generating a further picture bitstream based on the second picture data relating to the second view and the area of common characteristics.

4. The method according to claim 1, wherein performing prediction includes deciding on a prediction mode based on the area of common characteristics.

5. The method according to claim 1, wherein performing prediction includes determining an extent of a prediction area based on the area of common characteristics.

6. The method according to claim 5, wherein the extent of the prediction area is determined in a form of prediction size units.

7. The method according to claim 1, wherein performing feature matching includes determining a set of positions defining the area of common characteristics.

8. The method according to claim 1, wherein all steps are performed on an encoder side.

9. The method according to claim 1, further comprising multiplexing bitstreams so as to convey the picture data in an encoded form toward a decoding side.

10. A method for multiview video data decoding, comprising:
obtaining a picture bitstream;
obtaining a residual data bitstream;
decoding encoded picture data conveyed by said picture bitstream so as to obtain first picture data relating to a first view;
obtaining a prediction error from said residual data bitstream; and
generating second picture data relating to a second view from said prediction error and at least a part of said decoded first picture data.

11. The method according to claim 10, wherein generating the second picture data includes obtaining a second picture bitstream and decoding encoded picture data conveyed by said second picture bitstream so as to obtain remaining picture data being combined with the second picture data for reproducing the second view.

12. The method according to claim 10, wherein said residual data bitstream includes information related to a prediction mode decided based on an area of common characteristics in said first view and said second view.

13. The method according to claim 10, wherein generating second picture data includes combining the prediction error with at least the part of the decoded first picture data.

14. The method according to claim 10, further comprising de-multiplexing bitstreams from a multiplexed bitstream received from an encoding side.

15. The method according to claim 10, wherein said picture data include data that contains, indicates and/or can be processed to obtain an image, a picture, a stream of pictures/images, a video, and a movie.

16. A multiview video data encoding device comprising:
a processor and a memory storing code, which when executed by the processor, causes the processor to perform the method according to claim 1.

17. A multiview video data decoding device comprising:
a processor and a memory storing code, which when executed by the processor, causes the processor to:
obtain a picture bitstream;
obtain a residual data bitstream;
decode encoded picture data conveyed by said picture bitstream so as to obtain first picture data relating to a first view;
obtain a prediction error from said residual data bitstream; and
generate second picture data relating to a second view from said prediction error and at least a part of said decoded first picture data.

18. The multiview video data decoding device according to claim 17 comprising a communication interface configured to receive communication data conveying the picture bitstream and the residual data bitstream over a communication network.

19. The multiview video data decoding device according to claim 18, wherein the communication interface is adapted to perform communication over a wireless mobile network.

20. The multiview video data decoding device according to claim 17, further comprising a display configured to display content based on the obtained picture bitstream and residual data bitstream.
